(19) United States
(12) Patent Application Publication
(10) Pub. No.: US 2018/0341372 A1
(43) Pub. Date: Nov. 29, 2018

(54) RADIO CONTENT REPLAY

(71) Applicant: iHeartMedia Management Services, Inc., San Antonio, TX (US)

(72) Inventors: Corey M. Kahn, Brooklyn, NY (US); Taichi Matsumoto, North Bergen, NJ (US); Eric Chan, Forest Hills, NY (US); Kisik Kim, Edgewater, NJ (US); Chunan Li, Syosset, NY (US); Zachary J. Stayman, Brooklyn, NY (US); Steven F. Radley, Hastings, NY (US)

(73) Assignee: iHeartMedia Management Services, Inc.

(21) Appl. No.: 15/604,276

(22) Filed: May 24, 2017

(51) Int. Cl. G06F 3/0482; H04L 29/06; H04W 4/00; G06F 3/16

(52) U.S. Cl. CPC G06F 3/0482; H04L 65/601; H04W 4/001; H04L 67/42; H04L 65/4076; G06F 3/165; H04L 65/4084

(57) ABSTRACT

A device includes a processor, a first interface, and a second interface. The first interface is configured to receive a media stream corresponding to a live radio broadcast. The media stream includes a content item and an identifier of the content item. The processor is configured to provide data to a display in response to receiving a replay selection. The data corresponds to a list of identifiers of a plurality of received content items. The processor is also configured to receive an input indicating a particular identifier of the list of identifiers. The second interface is configured to send a request to a remotely located on-demand content source. The request includes the particular identifier. The second interface is configured to receive a particular content item from the on-demand content source. The particular content item corresponds to the particular identifier. Other aspects are also disclosed.

### I. FIELD

The present disclosure relates to systems and methods of radio content replay.

### II. BACKGROUND

Content of a radio broadcast stream is played sequentially to a user. For example, a live radio broadcast includes a first music track followed by a second music track. A user does not generally have the ability to replay a music track from the beginning while listening to a live radio broadcast via a user device. For example, if a user starts listening to the live radio broadcast in the middle of the music track, the user misses the beginning of the music track. Consequently, the inability to replay the music track may adversely impact user experience. As another example, a user listens to a music track of the live radio broadcast. The user decides, subsequent to listening to the music track, that the user would like to replay the music track. In this case, the user is too late to initiate copying of the music track for replaying, and pre-emptively storing all content received from the radio broadcast stream at the user device in case the user requests to replay a content item would consume memory resources of the user device. In addition, some user devices may not have the ability or the memory resources to store all received content.

As an alternative to recording a radio broadcast, a content item that a user is interested in replaying may be accessible from an on-demand content source. The user may access a music track from the on-demand content source by requesting the music track. In a particular example, a music track that is played during the live radio broadcast is also accessible via the on-demand content source. However, the process of a user determining that the music track is available via the on-demand content source and requesting the music track from the on-demand content source may be time-consuming and inconvenient for the user.

### III. SUMMARY

Systems and methods of radio content replay are disclosed. A media stream corresponding to a live radio broadcast may include a music track, a talk show, a weather report, etc. The media stream may be generated by a radio content source. Some (or all) of the content of the radio broadcast may also be stored at an on-demand content source. In an illustrative example, a music track that is included in the radio broadcast is also available via the on-demand content source. The media stream from the radio content source includes content identifiers associated with content items that are also available via the on-demand content source. A music track is retrievable from the on-demand content source using a content identifier associated with the music track.

A media player of a user device may receive the media stream corresponding to the live radio broadcast. The media stream includes a content item and an identifier of the content item. For example, the media stream may correspond to a radio show during which a radio jockey selects content items (e.g., music tracks) for live broadcast based on listener requests. The radio content source may maintain (or access) data indicating the identifier of the content item corresponding to the on-demand content source. The identifier corresponds to the on-demand content source if the content item is retrievable from the on-demand content source using the identifier. The radio content source includes the identifier in the media stream to indicate that the content item is also available via the on-demand content source. The media player determines that the content item is also available via the on-demand content source in response to determining that the media stream includes the identifier of the content item that is associated with the on-demand content source. Having the media player automatically determine whether the content item is also available via the on-demand content source based on determining that the media stream includes the identifier is faster and more convenient to a user, as compared to the user searching for the content item at the on-demand content source.

The media player may generate a first graphical user interface (GUI) including a replay option in response to determining that the content item is also available via the on-demand content source. The media player may provide the first GUI to a display. The media player may provide the first GUI to the display concurrently with (or subsequent to) providing an audio signal corresponding to the content item to a speaker. The replay option of the first GUI indicates to a user that the content item is available for replay. Having the replay option automatically indicate to the user that a content item is available for replay may improve user experience as compared to the user having to determine whether the content item is available for replay by searching on-demand content sources.

The media player, in response to receiving a first input indicating a selection of the replay option, generates a second GUI indicating a plurality of options. Each option of the plurality of options may correspond to a particular identifier of a list of identifiers. The list of identifiers may include the identifier. The list of identifiers may include a first identifier of a received content item. In a particular example, the first identifier is the same as the identifier received in the media stream corresponding to the live radio broadcast. In another example, the media player receives the first identifier in a second media stream. The second media stream may correspond to another live radio broadcast. For example, the media stream corresponds to the live radio broadcast of a first radio station, and the second media stream corresponds to another live radio broadcast of a second radio station. A user may switch from listening to one radio station to listening to the other radio station. The plurality of options of the second GUI may indicate to the user that corresponding received content items are available for replay. The second GUI may enable a user to replay at least one of a particular number (e.g., 3) of the most recently received content items. The received content items may include a content item received via one media stream corresponding to the first radio station and another content item received via another media stream corresponding to the second radio station. The second GUI may enable the user to replay a content item of a previously received media stream. The media player may provide the second GUI to the display.

The media player may, in response to receiving a second input indicating a selection of a first option corresponding to the first identifier, send a request to the on-demand content source. The request may include the first identifier. The media player may receive a first content item from the on-demand content source. The first content item may correspond to the first identifier. The media player may output (e.g., replay) an audio signal corresponding to the first content item via the speaker. For example, the media player outputs an audio signal corresponding to the beginning of the first content item via the speaker. After the first content item is played, the media player may revert to providing an audio signal corresponding to the media stream from the radio content source to the speaker. The replay GUI may automatically indicate to the user content items that are available for replay without the user having to search for content items at the on-demand content source. Automatically determining that a content item is available for replay based on determining that an identifier corresponding to an on-demand content source is faster than a user searching for the content item at the on-demand content source. Selecting a content item that is indicated as replayable is more convenient for a user, as compared to the user searching for the content item at the on-demand content source. Retrieving (e.g., streaming) a user selected content item from the on-demand content source conserves memory usage of the user device, as compared to pre-emptively storing all content received in a media stream of a live radio broadcast at the user device.

In a particular aspect, a device includes a processor, a first interface coupled to the processor, and a second interface coupled to the processor. The first interface is configured to receive a media stream corresponding to a live radio broadcast. The media stream includes a content item and an identifier of the content item. The processor is configured to provide data to a display in response to receiving a replay selection (e.g., a user input). The data corresponds to a list of identifiers of a plurality of received content items. The processor is also configured to receive an input indicating a particular identifier of the list of identifiers. The second interface is configured to send a request, via a network, to a remotely located on-demand content source. The request includes the particular identifier. The second interface is also configured to receive a particular content item from the on-demand content source. The particular content item corresponds to the particular identifier.

In another particular aspect, a method includes receiving, at a device, a media stream corresponding to a live radio broadcast. The media stream includes a content item and an identifier of the content item. The identifier is associated with a remotely located on-demand content source. The method also includes generating, at the device, a first graphical user interface (GUI) including at least a replay option. The method further includes providing the first GUI to a display. The method also includes receiving a first input indicating a selection of the replay option. The method further includes generating a second GUI including a plurality of options. Each option of the plurality of options corresponds to a particular identifier of the list of identifiers. The list of identifiers includes the identifier. The method further includes providing the second GUI to the display.

In another particular aspect, a computer-readable storage device stores instructions that, when executed by a processor, cause the processor to perform operations including receiving a media stream corresponding to a live radio broadcast. The media stream includes a content item and an identifier of the content item. The operations also include providing data to a display in response to receiving a replay selection. The data corresponds to a list of identifiers of a plurality of received content items. The operations further include receiving an input indicating a particular identifier of the list of identifiers. The operations also include sending a request, via a network, to a remotely located on-demand content source. The request includes the particular identifier. The operations further include receiving a particular content item from the on-demand content source. The particular content item corresponds to the particular identifier.

Aspects, advantages, and features of the present disclosure will become apparent after review of the entire application, including the following sections: Brief Description, Detailed Description, and the Claims.

### IV. BRIEF DESCRIPTION

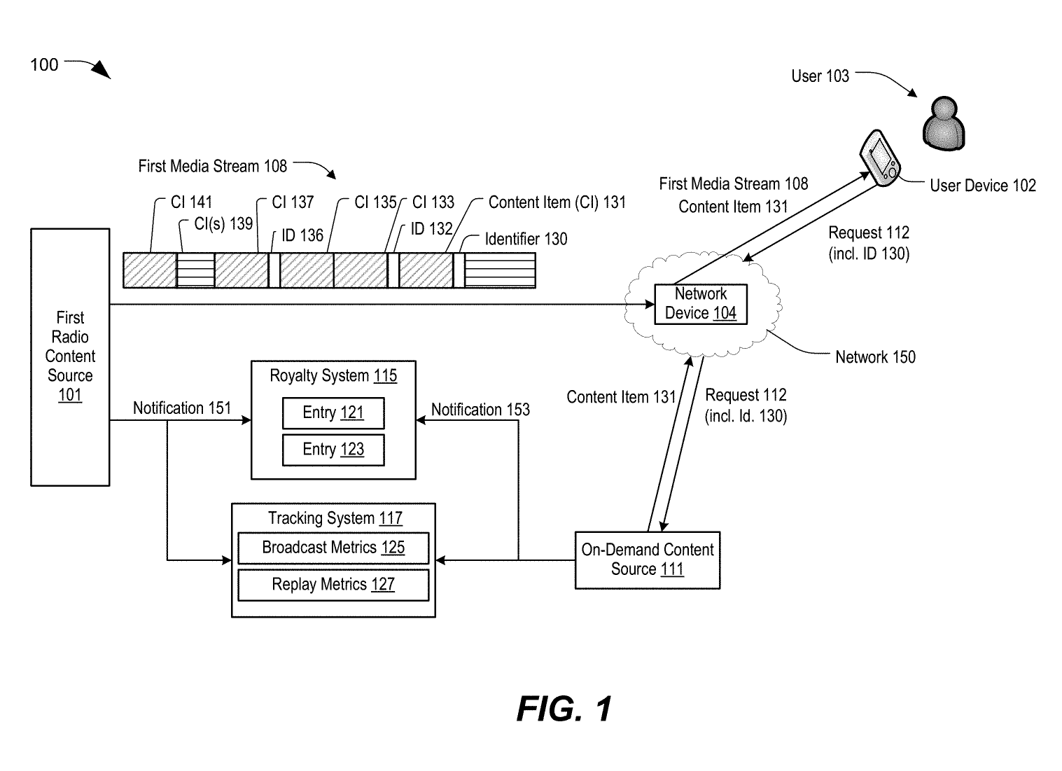

FIG. 1 is a block diagram of a particular illustrative aspect of a system that includes a device that is operable to replay live radio content;

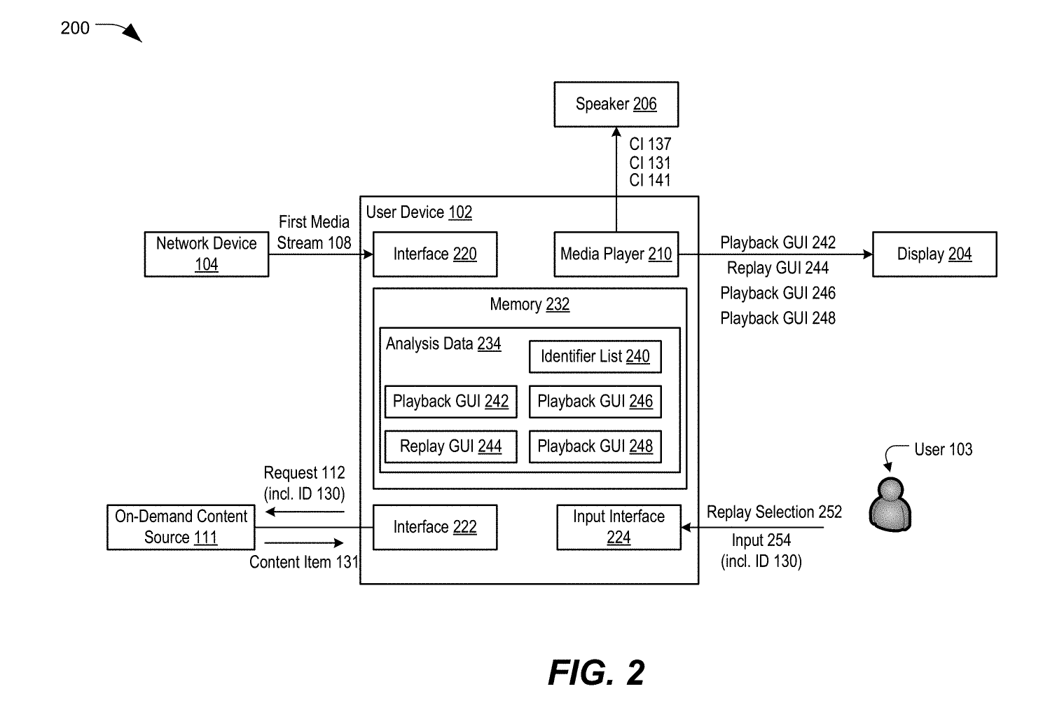

FIG. 2 is a diagram of a particular illustrative aspect of the system of FIG. 1;

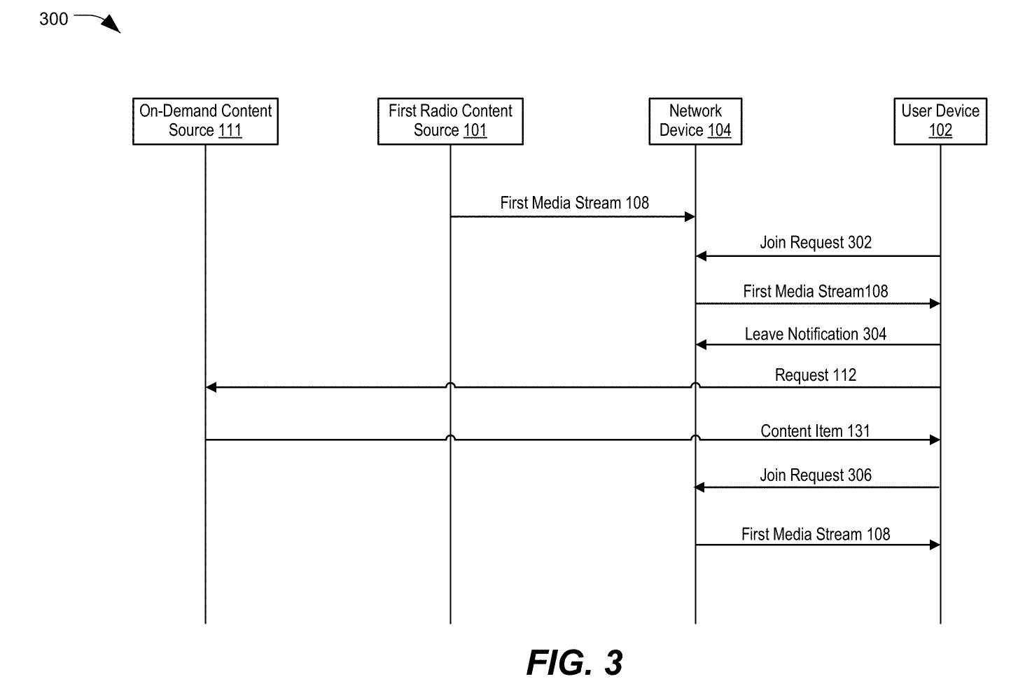

FIG. 3 is a ladder diagram that illustrates communication between components of the system of FIG. 1;

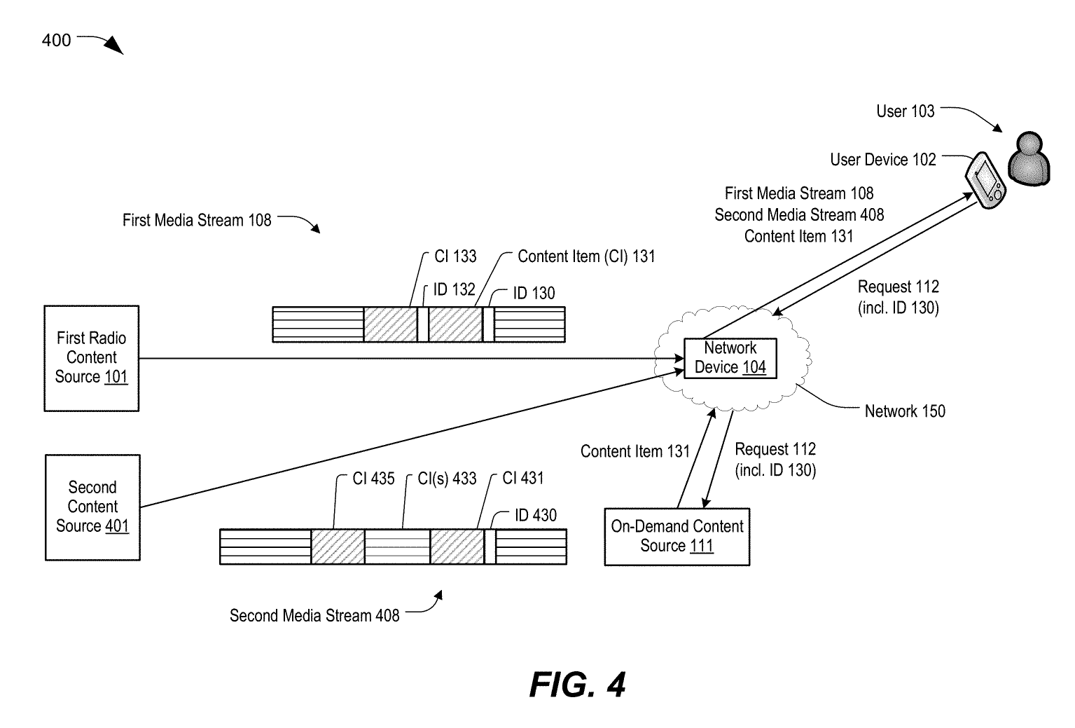

FIG. 4 is a diagram of a particular illustrative aspect of the system of FIG. 1;

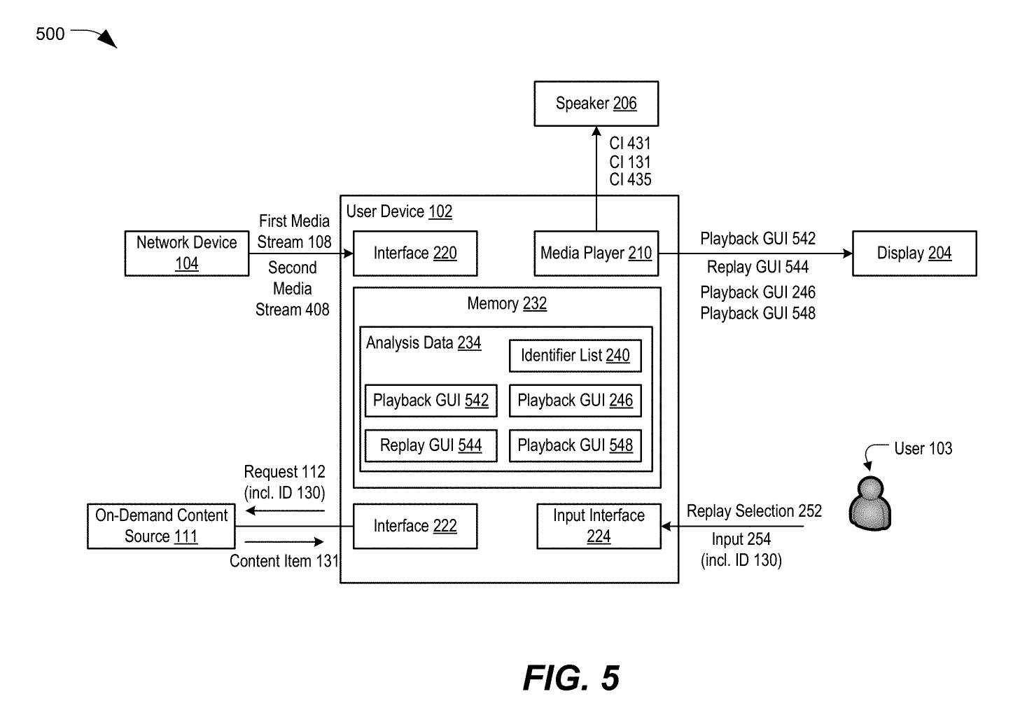

FIG. 5 is a diagram of a particular illustrative aspect of the system of FIG. 1;

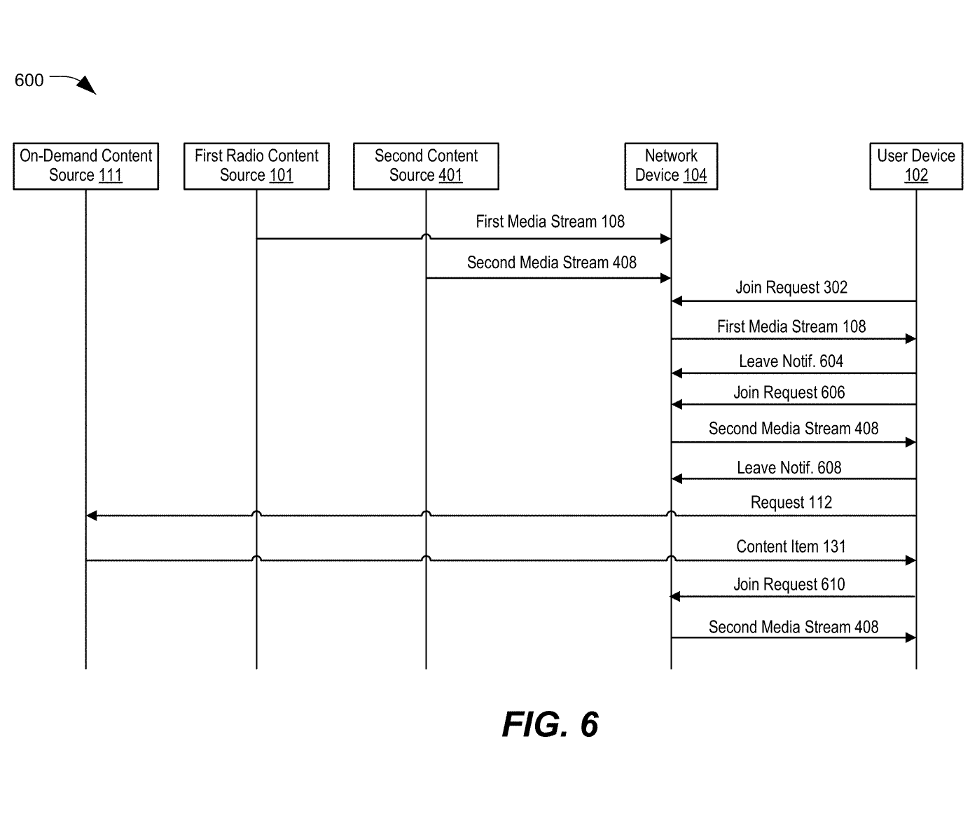

FIG. 6 is a ladder diagram of a particular illustrative aspect of a method of operation of the system of FIG. 4;

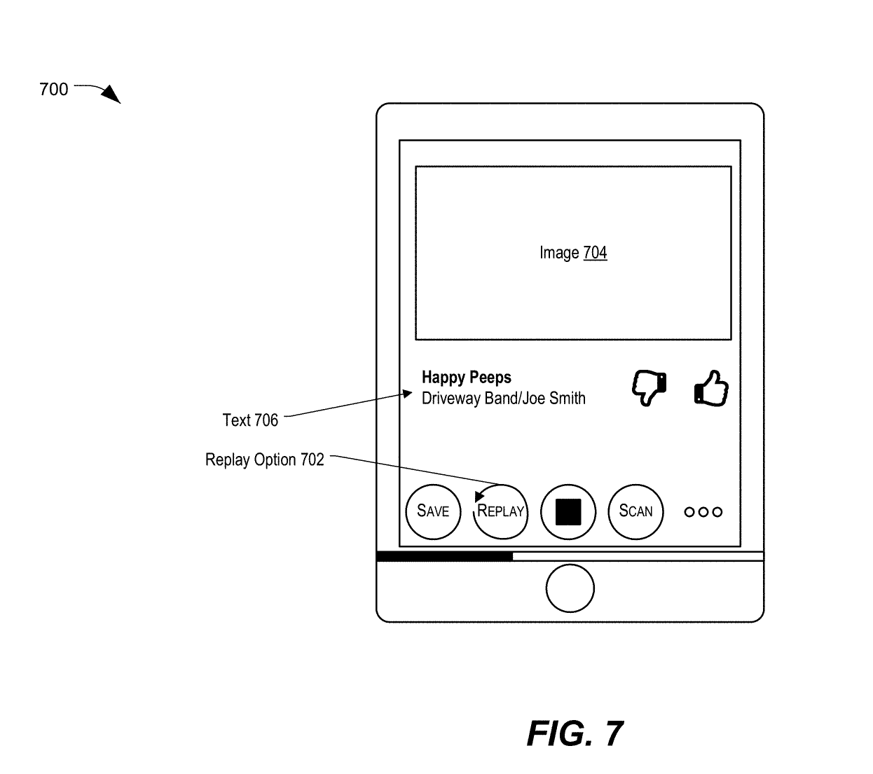

FIG. 7 is a diagram of a particular illustrative aspect of a graphical user interface (GUI) generated by the system of FIG. 1;

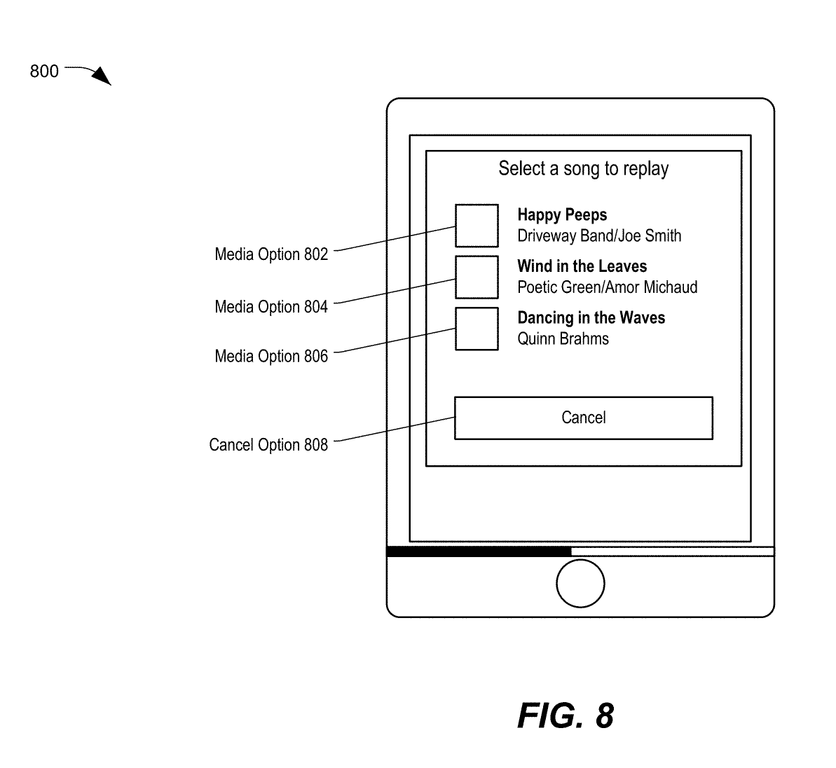

FIG. 8 is a diagram of a particular illustrative aspect of a GUI generated by the system of FIG. 1;

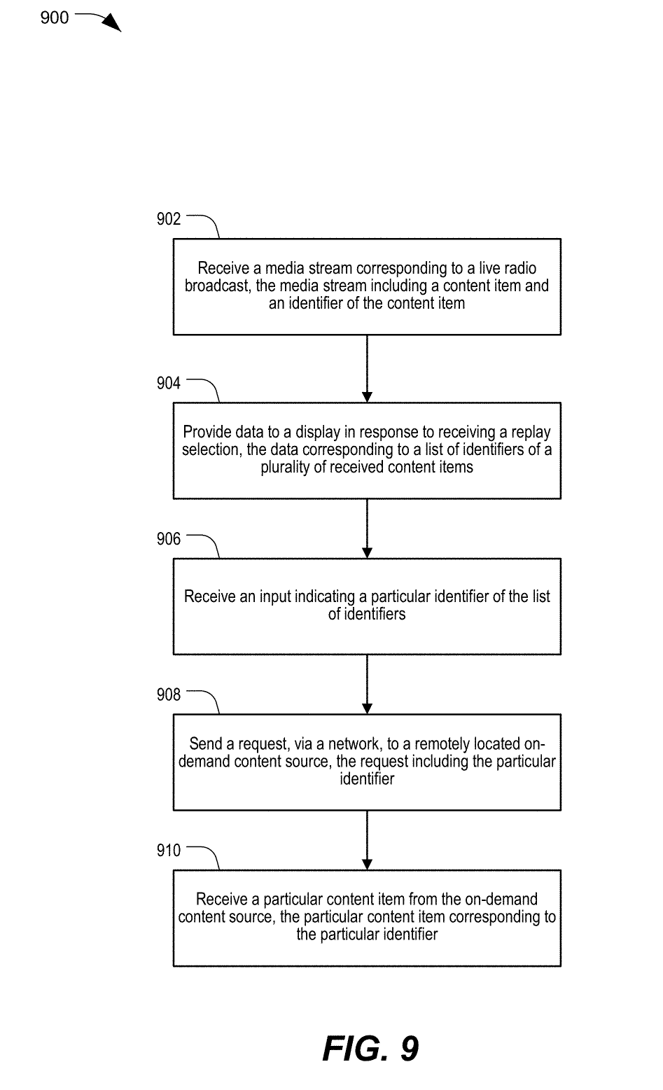

FIG. 9 is a flow chart to illustrate a method of radio content replay;

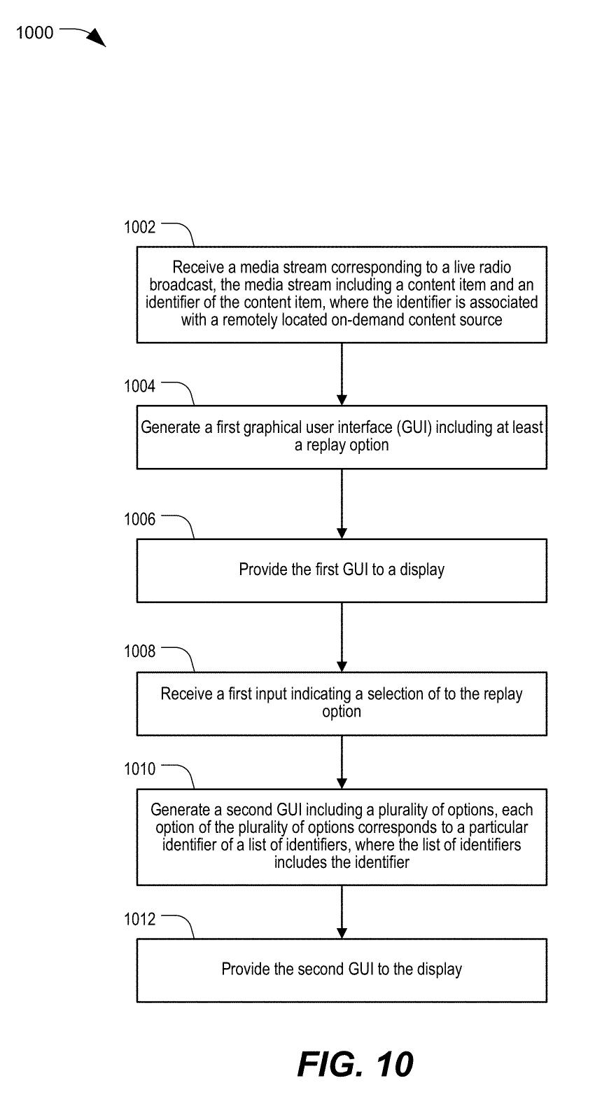

FIG. 10 is a flow chart to illustrate a method of radio content replay; and

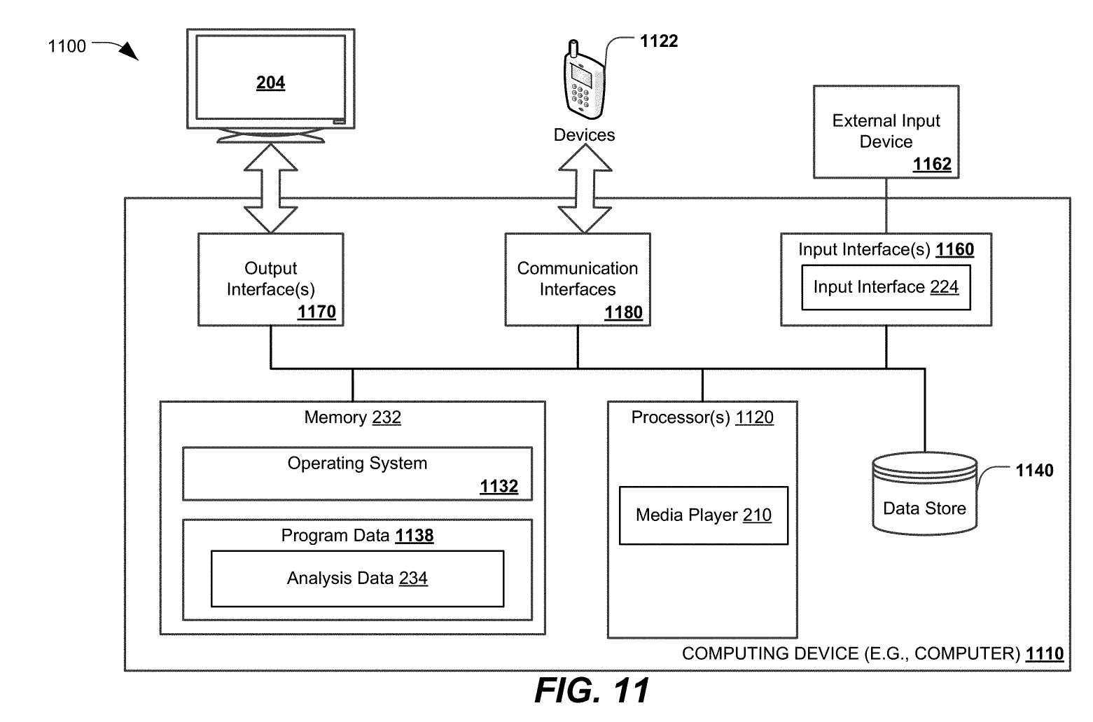

FIG. 11 is a block diagram of a device operable to perform radio content replay in accordance with the devices and methods of FIGS. 1-10.

### V. DETAILED DESCRIPTION

The terminology used herein is for the purpose of describing particular aspects only and is not intended to be limiting of the claims. As used herein, the singular forms “a,” “an,” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Referring to FIG. 1, a system is shown and generally designated 100. The system 100 includes a user device 102 coupled, via a network 150, to a first radio content source 101 and to an on-demand content source 111. The user device 102 may include a mobile phone, a radio device, a transportation device, a communication device, an entertainment device, a desktop computer, a laptop computer, a tablet computer, or a combination thereof. The network 150 may include a wired network, a wireless network, or both. The first radio content source 101 may be remotely located from the on-demand content source 111. In an alternative aspect, the first radio content source 101 is co-located with the on-demand content source 111. Each of the first radio content source 101 and the on-demand content source 111 may be remotely located from the user device 102. In an alternative aspect, the user device 102 is co-located with the first radio content source 101, the on-demand content source 111, or both. The network 150 includes a network device 104 (e.g., an edge router). The user device 102 is coupled, via the network device 104, to the first radio content source 101.

The first radio content source 101 is configured to transmit a first media stream 108. The first media stream 108 corresponds to a live radio broadcast. The live radio broadcast may be associated with a particular radio station. The network device 104 is configured to forward the first media stream 108 to the user device 102. For example, the network device 104 forwards the first media stream 108 to the user device 102 in response to receiving a join request from the user device 102.

The on-demand content source 111 is configured to store one or more content items (CIs). As further described with reference to FIG. 2, the user device 102 includes a first interface and a second interface configured to communicate with the network device 104 and the on-demand content source 111, respectively. In a particular aspect, the first interface is the same as the second interface. In an alternative aspect, the first interface is distinct from the second interface. The user device 102 includes a media player (e.g., a processor) configured to enable access to media content.

The system 100 may include a royalty system 115 coupled to the first radio content source 101, the on-demand content source 111, or both. The royalty system 115 is configured to generate a royalty entry indicating whether a content item is included in a broadcast media stream or in an on-demand media stream. The royalty system 115 may determine a licensing fee associated with the content item based on the royalty entry. The system 100 may include a tracking system 117 coupled to the first radio content source 101, the on-demand content source 111, or both. The tracking system 117 is configured to generate broadcast metrics 125, replay metrics 127, or a combination thereof. The broadcast metrics 125 are related to content items that have been included in at least one broadcast media stream. The replay metrics 127 are related to content items that have been included in at least one on-demand content stream.

During operation, the first radio content source 101 may initiate transmission of the first media stream 108 to the network device 104. The first media stream 108 may include a CI 131, a CI 133, a CI 135, a CI 137, one or more CI(s) 139, a CI 141, one or more additional CIs, or a combination thereof. A particular CI may include a music track, a talk show, a news report, a weather report, a traffic report, an advertisement, or a combination thereof. The first media stream 108 includes identifiers of one or more of the CIs, the identifiers corresponding to the on-demand content source 111. For example, the first media stream 108 includes an identifier (ID) 130 of the CI 131, an ID 132 of the CI 133, an ID 136 of the CI 137, one or more additional IDs, or a combination thereof. An ID of a particular CI corresponding to the on-demand content source 111 is usable to retrieve the particular CI from the on-demand content source 111. For example, the ID 130 is usable to retrieve the CI 131 from the on-demand content source 111.

In a particular aspect, the first radio content source 101 maintains (or has access to) broadcast-ID-to-on-demand-ID mapping data. The CI 131 may have a broadcast ID. The broadcast ID is associated with the first radio content source 101. For example, the first radio content source 101 is configured to retrieve the CI 131 from memory (or another device) using the broadcast ID. The first radio content source 101 may determine that the broadcast-ID-to-on-demand-ID mapping data indicates that the broadcast ID maps to the ID 130 corresponding to the on-demand content source 111.

In a particular aspect, the on-demand content source 111 maintains ID-to-location mapping data. The ID-to-location mapping data indicates that the ID 130 corresponds to a memory location. For example, the ID 130 corresponds to an address of the memory location. The on-demand content source 111 may be configured to retrieve the CI 131 from the memory location. An ID of the CI 135 may be absent from the first media stream 108. For example, the CI 135 is not stored at the on-demand content source 111. Consequently, an ID of the CI 135 associated with the on-demand content source 111 is unavailable.

The network device 104 forwards the first media stream 108 to the user device 102. Although an ID (e.g., an on-demand ID) is illustrated as preceding a corresponding CI in the first media stream 108, it should be understood that the ID may be interspersed with the corresponding CI. For example, a CI is sent as multiple network packets of the first media stream 108 and one or more of the packets include the ID.

The user device 102 receives the first media stream 108 via the first interface. The user device 102 (e.g., the media player) may provide an audio signal corresponding to the first media stream 108 to a speaker and may provide a GUI to a display, as further described with reference to FIG. 2. For example, the user device 102 generates a playback GUI including a replay option in response to determining that the first media stream 108 includes the ID 136 of the CI 137, as further described with reference to FIGS. 2 and 7. The user device 102 may provide the playback GUI to a display concurrently with providing the CI 137 to the speaker. As used herein, “providing a content item to a speaker” includes generating an audio signal based on the content item, and providing the audio signal to the speaker. The user device 102 may add the ID 136 to a list of IDs corresponding to content items that have been previously received by the user device 102.

A user 103 may select the replay option. The user device 102 may generate a replay GUI in response to receiving a selection of the replay option, as further described with reference to FIGS. 2 and 8. The replay GUI includes data (e.g., media options) corresponding to the list of IDs, as further described with reference to FIG. 8. Each of the media options may be selectable to replay a CI associated with a corresponding ID. For example, the replay GUI includes a first media option corresponding to the ID 130 of the CI 131, a second media option corresponding to the ID 132 of the CI 133, a third media option corresponding to an ID 136 of the CI 137, or a combination thereof. The user device 102 provides the replay GUI to the display.

The user 103 may choose the CI 131 for replay by selecting the first media option. The user device 102, in response to receiving an input indicating a selection of the CI 131, sends a request 112 to the on-demand content source 111. The request 112 includes the ID 130 of the CI 131. The on-demand content source 111, in response to receiving the request 112, sends the CI 131 to the user device 102. The user device 102 receives the CI 131, via the second interface, from the on-demand content source 111. The user device 102 may output the CI 131 via the speaker, as further described with reference to FIG. 2. As used herein, “output of a content item via a speaker” includes generation of an audio signal based on the content item, and output of the audio signal via the speaker. For example, the user device 102 generates an audio signal based on the CI 131 and outputs the audio signal via the speaker or other audio output device, such as headphones. In this aspect, the user 103 uses the replay option of the playback GUI corresponding to the CI 137 to select another content item (e.g., the CI 131) for replay. In an alternative aspect, the user 103 chooses the CI 137 for replay. In this aspect, the request 112 includes the ID 136 of the CI 137. The user device 102 may receive the CI 137 from the on-demand content source 111 and may provide the CI 137 to the speaker. For example, the user device 102 generates an audio signal based on the CI 137 received from the on-demand content source 111 and provides the audio signal to the speaker. In this aspect, the user 103 uses the replay option of the playback GUI corresponding to the CI 137 to replay the CI 137.

In a particular aspect, the CI 131 included in the first media stream 108 corresponds to a modified version of the CI 131 stored at the on-demand content source 111. For example, the CI 131 stored at the on-demand content source 111 corresponds to an original version of the CI 131. At least a portion of the CI 131 may be stretched, reduced, or removed for inclusion in the first media stream 108 to accommodate a playout time window, such as a length of a radio show. As another example, at least a portion of the CI 131 may overlap other content, such as a voice of a radio announcer, in the first media stream 108. A copy of the CI 131 generated by copying a portion of the first media stream 108 received at the user device 102 may differ from the CI 131 received from the on-demand content source 111. Replaying the CI 131 received from the on-demand content source 111 may improve user experience as compared to replaying a copy of the CI 131 received in the first media stream 108.

The royalty system 115 may generate an entry 121 (e.g., a first royalty entry) based on inclusion of the CI 131 in the first media stream 108, and may generate an entry 123 (e.g., a second royalty entry) based on sending the CI 131 from the on-demand content source 111 to the user device 102. For example, the royalty system 115 generates the entry 121 in response to receiving a notification 151 from the first radio content source 101 indicating that the CI 131 has been added, at a particular time, to the first media stream 108. The entry 121 may indicate the first radio content source 101, the CI 131, the particular time, the first media stream 108, or a combination thereof. For example, the entry 121 indicates that the CI 131 has been added, at the particular time, to the first media stream 108 by the first radio content source 101. The royalty system 115 may generate the entry 123 in response to receiving a notification 153 from the on-demand content source 111 indicating that the CI 131 has been sent, at a particular time, to the user device 102. The entry 123 may indicate the on-demand content source 111, the CI 131, the particular time, the user device 102, or a combination thereof. For example, the entry 123 indicates that the CI 131 has been sent, at the particular time, to the user device 102 by the on-demand content source 111. The entry 121 may correspond to a first payment to a license holder of the CI 131. The entry 123 may correspond to a second payment to the license holder. The first payment may be the same as or distinct from the second payment.

The tracking system 117 may generate (or update) the broadcast metrics 125 based at least in part on inclusion of the CI 131 in the first media stream 108. For example, the tracking system 117 generates (or updates) the broadcast metrics 125 in response to receiving the notification 151 from the first radio content source 101 indicating that the CI 131 has been added, at a particular time, to (e.g., broadcast via) the first media stream 108. The broadcast metrics 125 may indicate the first radio content source 101, the CI 131, the particular time, the first media stream 108, or a combination thereof. For example, the broadcast metrics 125 indicate that the CI 131 has been added, at the particular time, to the first media stream 108 by the first radio content source 101. The tracking system 117 may generate the replay metrics 127 based at least in part on sending the CI 131 from the on-demand content source 111 to the user device 102. For example, the tracking system 117 generates (or updates) the replay metrics 127 in response to receiving the notification 153 from the on-demand content source 111 indicating that the CI 131 has been sent, at a particular time, to (e.g., replayed at) the user device 102. The replay metrics 127 may indicate the on-demand content source 111, the CI 131, the particular time, the user device 102, or a combination thereof. For example, the replay metrics 127 indicate that the CI 131 has been sent (e.g., for replay), at the particular time, to the user device 102 by the on-demand content source 111.

The system 100 thus enables replay of one or more CIs that are received via the first media stream 108 corresponding to a live radio broadcast. Replay functionality is enabled at the user device 102 without a substantial increase (e.g., with no increase) in memory usage at the user device 102. For example, multiple CIs are available for replay from the on-demand content source 111 without preemptively storing the CIs locally at the user device 102.

Referring to FIG. 2, a system is shown and generally designated 200. The system 200 may correspond to the system 100 of FIG. 1. The system 200 includes the user device 102 coupled, via an interface 220, to the network device 104. The user device 102 is coupled, via an interface 222, to the on-demand content source 111. In a particular aspect, the interface 220 is the same as the interface 222. For example, the interface 220 and the interface 222 correspond to a wireless network interface. In an alternate aspect, the interface 220 is distinct from the interface 222. For example, the interface 220 corresponds to a wired network interface and the interface 222 corresponds to a wireless network interface.

The user device 102 includes an input interface 224. The input interface 224 may be configured to receive user input, such as a keyboard input, a mouse input, a touch screen input, a button input, a dial input, an audio input, a visual input, or a combination thereof. The user device 102 includes a media player 210 coupled to a speaker 206 and to a display 204. The speaker 206 may include a loudspeaker, a headphone, or another audio output. The display 204 may include a monitor, an integrated display screen, a liquid crystal display (LCD) screen display, a light emitting diode (LED) screen display, a touch screen display, a high definition (HD) display, or a combination thereof. The media player 210 is configured to enable access to media. In a particular aspect, the media player 210 corresponds to a processor that is configured to perform one or more operations described herein. In a particular aspect, the media player 210 corresponds to instructions that, when executed by a processor, cause the processor to perform one or more operations described herein. The user device 102 includes memory 232. The memory 232 is configured to store analysis data 234.

During operation, the user device 102 receives the first media stream 108, via the interface 220, from the network device 104. The first media stream 108 corresponds to a live radio broadcast. The live radio broadcast may be associated with a radio station. For example, the user 103 selects an icon displayed on the display 204 to activate the media player 210. The media player 210 may, in response to receiving the selection of the icon, provide a GUI to the display 204 with an option corresponding to the radio station. The user 103 may “tune” to the radio station by selecting the option. The media player 210 may send a request to the network device 104 in response to receiving a user selection of the option. In a particular aspect, the request corresponds to a request to join a multicast group associated with the radio station. The network device 104 may add the user device 102 to the multicast group. The network device 104, in response to receiving the request, forwards the first media stream 108 to the user device 102. For example, the network device 104 forwards the first media stream 108 to the multicast group (including the user device 102). The user device 102 receives the first media stream 108 via the interface 220. For example, the user device 102 receives the ID 130, the CI 131, the ID 132, the CI 133, the CI 135, the ID 136, the CI 137 of FIG. 1, or a combination thereof.

The media player 210 may maintain an identifier list 240 to track IDs of content items that have been previously received by the user device 102. It should be understood that “list” is used as an illustrative example. In some aspects, the media player 210 maintains a data structure other than a list, such as a set, to track IDs of previously received content items. The identifier list 240 may include the ID 130 and the ID 132 indicating that the CI 131 and the CI 133, respectively, have been received by the user device 102.

In a particular aspect, the identifier list 240 indicates IDs of content items independently of a receipt order of the content items. In this aspect, the identifier list 240 indicates IDs of content items that have previously been provided to the speaker 206. For example, the CI 131, the CI 133, or both, are received concurrently with the CI 137. To illustrate, one or more first network packets corresponding to CI 133 are received interspersed with one or more second network packets corresponding to the CI 137. The media player 210 may store the second network packets in a network buffer while decoding the first network packets to generate (e.g., reproduce) the CI 133. The media player 210 may provide the CI 133 to the speaker 206. The media player 210 may add the ID 132 to the identifier list 240 in response to initiating output of the CI 133 via the speaker 206.

The media player 210 may add the ID 136 of the CI 137 to the identifier list 240. For example, the media player 210 adds the ID 136 to the identifier list 240 in response to the user device 102 receiving the CI 137, the ID 136, or both. As another example, the media player 210 adds the ID 136 to the identifier list 240 in response to initiating output of the CI 137 via the speaker 206. The identifier list 240 may include up to a threshold number of IDs (e.g., 3 ID). The threshold number may be based on a configuration setting, a default value, a user input, or a combination thereof.

In a particular aspect, the identifier list 240 corresponds to first-in first-out (FIFO) data structure. For example, adding the ID 136 to the identifier list 240 when the identifier list 240 includes the threshold number of IDs automatically removes another ID (e.g., a second identifier) from the identifier list 240. As another example, the media player 210 is configured to, in response to determining that the identifier list 240 includes the threshold number of IDs, remove an ID from the identifier list 240 and add the ID 136 to the identifier list 240. The removed ID may be the ID that has been in the identifier list 240 for the longest duration, corresponds to the earliest played content item, or both.

The media player 210 may provide a playback GUI 242 to the display 204 concurrently with providing the CI 137 to the speaker 206. In a particular aspect, the media player 210 generates the playback GUI 242 in response to receiving the CI 137. The playback GUI 242 may indicate that output of the CI 137 via the speaker 206 has been initiated, as further described with reference to FIG. 7. For example, the playback GUI 242 includes a song title, an album title, an artist name, an image, text, or a combination thereof, corresponding to the CI 137, as further described with reference to FIG. 7. The media player 210 may generate the playback GUI 242 to include one or more playback options, as further described with reference to FIG. 7. The playback options enable user interaction with the media player 210. The playback options may include a replay option. For example, the media player 210 generates the playback GUI 242 to include a replay option in response to determining that the first media stream 108 includes the ID 136 corresponding to the on-demand content source 111.

The user 103 may select the replay option of the playback GUI 242. The media player 210 may receive, via the input interface 224, a replay selection 252 indicating that the replay option of the playback GUI 242 is selected. The media player 210 may generate a replay GUI 244 in response to receiving the replay selection 252. The replay GUI 244 includes one or more media options corresponding to the identifier list 240, as further described with reference to FIG. 8. For example, the media player 210, in response to determining that the identifier list 240 includes the ID 130, includes a particular media option corresponding to the CI 131 in the replay GUI 244. In a particular aspect, the replay GUI 244 includes one or more additional media options corresponding to one or more additional IDs included in the identifier list 240. The media player 210 may provide data to the display 204. The data may correspond to the replay GUI 244. For example, the data may include instructions (e.g., hypertext markup language (HTML) code) for generating (e.g., displaying) the replay GUI 244.

In a particular aspect, the media player 210 provides the replay GUI 244 independently of receiving the replay selection 252. In this aspect, the media player 210 provides the replay GUI 244 to the display 204 concurrently with providing the CI 137 to the speaker 206. The replay GUI 244 may include at least a portion of the playback GUI 242 in addition to the one or more media options. For example, the replay GUI 244 indicates that an audio signal corresponding to the CI 137 is being provided to (or is ready to be provided to) the speaker 206.

The replay GUI 244 may enable the user 103 to replay a content item corresponding to a media option. For example, the user 103 selects the particular media option corresponding to the CI 131. The media player 210 receives, via the input interface 224 (or another input interface), an input 254 indicating a selection of the particular media option. For example, the input 254 indicates the ID 130. The media player 210 may sends the request 112 to the on-demand content source 111 in response to receiving the input 254. In a particular aspect, the media player 210 also sends a leave notification to the network device 104 in response to receiving the input 254. The leave notification indicates that the media player 210 is leaving the multicast group associated with the radio station corresponding to the first media stream 108.

The request 112 indicates (e.g., includes) the ID 130. The on-demand content source 111 may retrieve the CI 131 corresponding to the ID 130 and may send (e.g., stream) the CI 131 to the user device 102. The media player 210 may provide the CI 131 that is received from the on-demand content source 111 to the speaker 206. The media player 210 adds the ID 130 to the identifier list 240. For example, the identifier list 240 indicates that the CI 131 is the most recently received content item or the most recently played out content item. As used herein, a “played out content item” includes a content item that is provided to the speaker 206.

The media player 210 may generate a playback GUI 246 corresponding to the CI 131, as further described with reference to FIG. 7. The media player 210 may provide the playback GUI 246 to the display 204. For example, the media player 210 provides the playback GUI 246 to the display 204 concurrently with providing the CI 131 (received from the on-demand content source 111) to the speaker 206.

In a particular aspect, the media player 210, subsequent to providing the CI 131 received from the on-demand content source 111 to the speaker 206, “tunes” back to the radio station corresponding to the first media stream 108. For example, the media player 210, subsequent to the providing the CI 131 to the speaker 206, reverts to providing the first media stream 108 to the speaker 206. The media player 210 may, subsequent to providing the CI 131 to the speaker 206, send a join request to the network device 104 to rejoin the multicast group associated with the radio station corresponding to the first media stream 108. The network device 104 may, in response to the join request, forward the first media stream 108 to the user device 102. For example, the media player 210 receives at least a portion of the CI 141 of FIG. 1 from the network device 104.

In a particular aspect, as illustrated in FIG. 1, the CI 141 is subsequent to the CI 137 in the first media stream 108, and the first media stream 108 includes one or more CI(s) 139 between the CI 137 and the CI 141. In this aspect, playback duration of the CI 131 may be greater than or equal to playback duration of the CI(s) 139. In another aspect, the CI 141 is subsequent to and next to the CI 137 in the first media stream 108. In another aspect, the CI 141 corresponds to an end portion of the CI 137. In this aspect, the playback duration of the CI 131 may be less than the playback duration of the CI 137. For example, the user 103 selects the CI 131 for replay subsequent to listening to a beginning portion of the CI 137. The media player 210 provides the CI 131 received from the on-demand content source 111 to the speaker 206. The media player 210, subsequent to providing the CI 131 to the speaker 206, receives the first media stream 108 including a subsequent portion (e.g., an end portion) of the CI 137. The media player 210 provides the CI 141 (e.g., the subsequent portion of the CI 137) to the speaker 206. The media player 210 adds an ID of the CI 141 to the identifier list 240 in response to determining that the first media stream 108 includes the ID corresponding to the on-demand content source 111. Alternatively, the media player 210 may refrain from updating the identifier list 240 in response to determining that an ID of the CI 141 corresponding to the on-demand content source 111 is absent from the first media stream 108.

The media player 210 may generate a playback GUI 248 corresponding to the CI 141, as further described with reference to FIG. 7. The media player 210 may provide the playback GUI 248 to the display 204. For example, the media player 210 provides the playback GUI 248 to the display 204 concurrently with providing the CI 141 to the speaker 206.

The media player 210 dynamically enables replay of a content item in response to determining that the first media stream 108 includes an ID of the content item that corresponds to the on-demand content source 111. The content item has been previously received via the first media stream 108 corresponding to a live radio broadcast.

Referring to FIG. 3, a communication exchange is disclosed and generally designated 300. One or more messages of the communication exchange 300 may be generated by the on-demand content source 111, the first radio content source 101, the network device 104, the user device 102, the system 100 of FIG. 1, the media player 210, the system 200 of FIG. 2, or a combination thereof.

During operation, the first radio content source 101 sends the first media stream 108 to the network device 104. The network device 104 may forward the first media stream 108 to one or more devices that have joined a multicast group associated with a radio station corresponding to the first media stream 108. The user device 102 sends a join request 302 to the network device 104 to receive data associated with the radio station. For example, as described with reference to FIG. 2, the media player 210 sends the join request 302 to the network device 104 in response to receiving an input indicating a user selection of an option corresponding to the radio station. The join request 302 may correspond to a request to join the multicast group associated with the radio station. In a particular aspect, the network device 104 sends a request indicating the radio station to the first radio content source 101 in response to receiving the join request 302 from the user device 102. In this aspect, the first radio content source 101 provides the first media stream 108 to the network device 104 responsive to the request from the network device 104.

The network device 104, in response to receiving the join request 302 from the user device 102, begins forwarding the first media stream 108 to the user device 102. For example, as described with reference to FIG. 2, the network device 104 receives the ID 130, the CI 131, the ID 132, the CI 133, the CI 135, the ID 136, the CI 137 of FIG. 1, or a combination thereof, from the first radio content source 101. The network device 104 may, subsequent to receiving the join request 302, send the ID 130, the CI 131, the ID 132, the CI 133, the CI 135, the ID 136, the CI 137, or a combination thereof, to the user device 102. In a particular aspect, the media player 210 outputs an audio signal based on the CI 131, the CI 133, the CI 135, and the CI 137 via the speaker 206. The media player 210 may provide the replay GUI 244 to the display 204 based on outputting an audio signal corresponding to the CI 137 to the speaker 206, as described with reference to FIG. 2.

The user device 102 sends a leave notification 304 for the network device 104. The leave notification 304 may indicate that the user device 102 is leaving the multicast group of the radio station. In a particular aspect, as described with reference to FIG. 2, the media player 210 sends the leave notification 304 to the network device 104 in response to receiving the input 254. The input 254 may indicate a user selection of a media option of the replay GUI 244, as described with reference to FIG. 2. The input 254 may indicate the ID 130 of the CI 131.

The user device 102 sends the request 112 to the on-demand content source 111. For example, as described with reference to FIG. 2, the media player 210, in response to determining that the input 254 indicates the ID 130 of the CI 131, sends the request 112 to the on-demand content source 111. The on-demand content source 111 sends the CI 131 to the user device 102 in response to receiving the request 112 indicating the ID 130. As described with reference to FIG. 2, the media player 210 may provide the CI 131 received from the on-demand content source 111 to the speaker 206. For example, the media player 210 generates an audio signal based on the CI 131 received from the on-demand content source 111 and provides the audio signal to the speaker 206.

The user device 102 may send a join request 306 to the network device 104. For example, as described with reference to FIG. 2, the media player 210 sends the join request 306 to the network device 104 subsequent to providing the CI 131 to the speaker 206. In a particular aspect, the media player 210 sends the join request 306 to the network device 104 in response to receiving a user selection of a cancel option (or a skip option). The playback GUI 246 of FIG. 2 associated with the CI 131 (received from the on-demand content source 111) may include the cancel option (or the skip option).

The network device 104, in response to receiving the join request 306 from the user device 102, begins (e.g., restarts) forwarding the first media stream 108 to the user device 102. For example, the network device 104, in response to receiving the join request 306, adds the user device 102 to the multicast group associated with the radio station. The network device 104 may forward the CI 141 of FIG. 1 to the multicast group subsequent to adding the user device 102 to the multicast group. For example, the network device 104 sends the CI 141 to the user device 102. The media player 210 may provide the first media stream 108 (e.g., the CI 141) to the speaker 206. For example, the media player 210 generates an audio signal based on the first media stream 108 and provides the audio signal to the speaker 206. The media player 210 may provide the audio signal based on the first media stream 108 to the speaker 206 subsequent to providing the audio signal based on the CI 131 received from the on-demand content source 111 to the speaker 206.

The communication exchange 300 thus illustrates communication between components of the system 100 to enable replay of the CI 131 at the user device 102. For example, replay of the CI 131 is enabled by sending the request 112 from the user device 102 to the on-demand content source 111 and sending the CI 131 from the on-demand content source 111 to the user device 102. The communication exchange 300 also illustrates that the network device 104 reverts to forwarding the first media stream 108 to the user device 102 subsequent to the on-demand content source 111 providing the CI 131 to the user device 102.

Referring to FIG. 4, a system is disclosed and generally designated 400. The system 400 may correspond to the system 100 of FIG. 1, the system 200 of FIG. 2, or both. The system 400 includes a second content source 401 coupled, via the network device 104, to the user device 102. In an alternative aspect, the first radio content source 101 is coupled, via the network device 104, to the user device 102, and the second content source 401 is coupled, via a second network device, to the user device 102. In this aspect, the second network device is distinct from the network device 104.

The second content source 401 is configured to transmit a second media stream 408. In a particular aspect, the second content source 401 corresponds to a second radio content source, and the second media stream 408 corresponds to a second live radio broadcast associated with a second radio station. The network device 104 may be configured to forward the second media stream 408 to the user device 102. For example, the network device 104 forwards the second media stream 408 to the user device 102 in response to receiving a join request from the user device 102. To illustrate, the network device 104, in response to receiving the join request, adds the user device 102 to a multicast group associated with the second radio station.

In a particular aspect, the second content source 401 corresponds to a second on-demand content source, and the second media stream 408 corresponds to on-demand content. In this aspect, the second content source 401 sends the second media stream 408 to the user device 102 (e.g., as a unicast stream) in response to receiving a request from the user device 102.

During operation, the network device 104 forwards the first media stream 108 to the user device 102, as described with reference to FIGS. 1-3. For example, the network device 104 sends the ID 130, the CI 131, the ID 132, the CI 133, or a combination thereof, to the user device 102. The user device 102 may add the ID 130, the ID 132, or both, to the identifier list 240, as further described with reference to FIG. 2.

The user device 102 may switch from receiving the first media stream 108 from the first radio content source 101 to receiving the second media stream 408 from the second content source 401. For example, the user 103 selects an option corresponding to the second content source 401, such as an option associated with the second radio station corresponding to the second content source 401. The user device 102 may, in response to receiving a user selection indicating the second content source 401, send a leave notification to the network device 104 indicating that the user device 102 is leaving a multicast group of the radio station associated with the first radio content source 101. In a particular aspect, the user device 102, in response to receiving the user selection, sends a join request to the network device 104 to join a second multicast group associated with the second radio station associated with the second content source 401, as further described with respect to FIG. 6. In an alternative aspect, the user device 102, in response to receiving the user selection, sends a request to the second content source 401 for the second media stream 408.

The user device 102 receives the second media stream 408 from the network device 104, the second content source 401, or both. For example, the second media stream 408 includes an ID 430 of a CI 431. The network device 104 (or the second content source 401) may send the ID 430, the CI 431, or both, to the user device 102.

The user device 102 adds the ID 430 to the identifier list 240 in response to receiving the CI 431, providing the CI 431 to the speaker 206 of FIG. 2, or both. The identifier list 240 may thus maintain identifiers of previously received CIs across media streams, content sources, or a combination thereof. The user device 102 may display a replay GUI corresponding to the CI 431, as further described with reference to FIG. 5. The replay GUI includes one or more media options corresponding to identifiers included in the identifier list 240, as further described with reference to FIG. 8. In a particular aspect, as further described with reference to FIG. 5, the replay GUI includes a media option corresponding to the CI 131 previously received via the first media stream 108. The user 103 may select the media option of the replay GUI.

The user device 102 may sends the request 112 to the on-demand content source 111 in response to receiving the selection of the media option. The on-demand content source 111 may sends the CI 131 to the user device 102 in response to receiving the request 112 from the user device 102. The user device 102 may, subsequent to receiving the CI 131 from the on-demand content source 111, revert to receiving the second media stream 408 from the second content source 401. For example, the user device 102, subsequent to receiving the CI 131 from the on-demand content source 111, sends a join request to the network device 104 to join (or rejoin) the second multicast group of the second radio station associated with the second content source 401. The network device 104 may, in response to receiving the join request, starts (or restarts) forwarding the second media stream 408 to the user device 102. For example, the network device 104 forwards a CI 435 of the second media stream 408 to the user device 102.

The second media stream 408 may include one or more CI(s) 433 subsequent to the CI 431 and prior to the CI 435. The network device 104 may provide the CI(s) 433 to the second multicast group subsequent to the user device 102 leaving the second multicast group and prior to the user device 102 rejoining the second multicast group.

The system 400 enables the user device 102 to replay the CI 131 (received from the on-demand content source 111) subsequent to switching from receiving the first media stream 108 corresponding to one station to receiving the second media stream 408 corresponding to another radio station. For example, the user device 102 receives the CI 131 via the first media stream 108 corresponding to a live radio broadcast of a first radio station. The user device 102 switches from receiving the first media stream 108 from the first radio content source 101 to receiving the second media stream 408 from the second content source 401 (e.g., another radio content source or an on-demand content source). The user device 102 sends the request 112 for the CI 131 to the on-demand content source 111, and replays the CI 131 received from the on-demand content source 111.

Referring to FIG. 5, a system is shown and generally designated 500. The system 500 may correspond to the system 400 of FIG. 4. The system 500 may differ from the system 200 of FIG. 2 in that the user device 102 switches from receiving the first media stream 108 from the first radio content source 101 to receiving the second media stream 408 from the second content source 401 (e.g., another radio content source or an on-demand content source).

During operation, the user device 102 receives, via the interface 220, the ID 130, the CI 131, the ID 132, the CI 133 of the first media stream 108, or a combination thereof. The media player 210 adds the ID 130, the ID 132, or both, to the identifier list 240, as described with reference to FIG. 2. The media player 210, in response to receiving a user input indicating the second content source 401 of FIG. 1, switches from receiving the first media stream 108 to receiving the second media stream 408. For example, the media player 210, in response to receiving the user input, sends a leave notification to the network device 104 to leave a first multicast group of a first radio station and sends a join notification to the network device 104 to join a second multicast group of a second radio station. The first multicast group is associated with the first media stream 108, and the second multicast group is associated with the second media stream 408. The network device 104 may switch from forwarding the first media stream 108 to forwarding the second media stream 408 to the user device 102. In an alternative aspect, the media player 210, in response to receiving the user input, sends the leave request to the network device 104 to leave the first multicast group, and sends a request to the second content source 401 (e.g., an on-demand content source) for the second media stream 408. The network device 104 may discontinue forwarding the first media stream 108 to the user device 102 in response to receiving the leave request. The second content source 401 may, in response to receiving the request, initiate sending the second media stream 408 to the user device 102.

The user device 102 may receive the second media stream 408 via the interface 220 (or another interface). For example, the media player 210 receives the ID 430, the CI 431, or both, of the second media stream 408. The media player 210 may provide the CI 431 to the speaker 206. The media player 210 may generate a playback GUI 542 corresponding to the CI 431, as further described with reference to FIG. 7. The media player 210, in response to determining that the second media stream 408 includes the ID 430 of the CI 431 and that the ID 430 corresponds to the on-demand content source 111, generates the playback GUI 542 to include a replay option. The media player 210 may provide the playback GUI 542 to the display 204 concurrently with providing the CI 431 to the speaker 206. In a particular aspect, the media player 210 provides the playback GUI 542 to the display 204 in response to initiating provision of the CI 431 to the speaker 206.

The media player 210 adds the ID 430 to the identifier list 240 in response to receiving the ID 430, determining that the ID 430 corresponds to the on-demand content source 111, initiating provision of the CI 431 to the speaker 206, or a combination thereof. It should be understood that a single on-demand content source 111 is described for ease of illustration, in some aspects a first ID (e.g., on-demand ID) of a first CI corresponds to a first on-demand content source, and a second ID of a second CI corresponds to a second on-demand content source that is distinct from the first on-demand content source. The media player 210 may add the first ID, the second ID, or both, to the identifier list 240. For example, the media player 210 adds the ID 130 to the identifier list 240 in response to receiving the ID 130, determining that the ID 130 corresponds to the on-demand content source 111, initiating provision of the CI 131 to the speaker 206, or a combination thereof. In this example, the media player 210 adds the ID 430 to the identifier list 240 in response to receiving the ID 430, determining that the ID 430 corresponds to an on-demand content source (e.g., the on-demand content source 111, the second content source 401, or another content source), initiating provision of the CI 431 to the speaker 206, or a combination thereof.

The user device 102 may receive, via the input interface 224, the replay selection 252 indicating that the replay option of the playback GUI 542 is selected. The media player 210 may generate a replay GUI 544 in response to receiving the replay selection 252. The replay GUI 544 includes one or more media options corresponding to one or more identifiers of the identifier list 240, as further described with reference to FIG. 8. For example, the replay GUI 544 includes a media option corresponding to the ID 130 of the CI 131. The media player 210 provides the replay GUI 544 to the display 204.

The media player 210 receives the input 254 indicating a selection of the media option corresponding to the ID 130. The media player 210 sends the request 112 to the on-demand content source 111 in response to receiving the input 254. The on-demand content source 111 sends the CI 131 to the user device 102 in response to receiving the request 112. The media player 210 may provide the CI 131 received from the on-demand content source 111 to the speaker 206, and may provide the playback GUI 246 to the display 204, as described with reference to FIG. 2.

The media player 210 may revert to providing the second media stream 408 to the speaker 206 subsequent to providing the CI 131 (received from the on-demand content source 111). For example, the media player 210 generates a first audio signal based on the CI 131 (received from the on-demand content source 111) and provides the first audio signal to the speaker 206. The media player 210 generates a second audio signal based on the second media stream 408 (e.g., the CI 435 of FIG. 4). The media player 210 provides the second audio signal to the speaker 206 subsequent to providing the first audio signal to the speaker 206. The CI 435 may be subsequent to the CI 431 in the second media stream 408. In a particular aspect, the second media stream 408 includes the CI(s) 433 subsequent to the CI 431 and prior to the CI 435. In another aspect, the CI 435 is next to the CI 431. In yet another aspect, the CI 431 corresponds to a first portion (e.g., a beginning portion) of a content item, and the CI 435 corresponds to a second portion (e.g., an ending portion) of the same content item.

The system 500 enables the media player 210 to replay the CI 131 previously received via the first media stream 108 subsequent to switching from outputting the first media stream 108 to outputting the second media stream 408. The media player 210 also automatically reverts to providing the second media stream 408 to the speaker 206 subsequent to initiating replay of the CI 131.

Referring to FIG. 6, a communication exchange is disclosed and generally designated 600. One or more messages of the communication exchange 600 may be generated by the on-demand content source 111, the first radio content source 101, the network device 104, the user device 102, the system 100 of FIG. 1, the media player 210, the system 200 of FIG. 2, the second content source 401, the system 400 of FIG. 4, or a combination thereof.

The communication exchange 600 may differ from the communication exchange 300 in that the user device 102 switches from receiving the first media stream 108 from the first radio content source 101 to receiving the second media stream 408 from the second content source 401. For example, the user device 102 sends a leave notification 604 to the network device 104 indicating that the user device 102 is leaving a multicast group of a first radio station associated with the first media stream 108. The user device 102 sends a join request 606 to the network device 104 to join a second multicast group of a second radio station associated with the second media stream 408. The network device 104 forwards the second media stream 408 to the user device 102.

The user device 102 sends a leave notification 608 to the network device 104 indicating that the user device 102 is leaving the second multicast group. The user device 102 sends the request 112 to the on-demand content source 111, and receives the CI 131 from the on-demand content source 111.

The user device 102, subsequent to receiving the CI 131, sends a join request 610 to the network device 104 to rejoin the second multicast group of the second radio station. The network device 104, subsequent to receiving the join request 610, reverts to forwarding the second media stream 408 to the user device 102.

Referring to FIG. 7, a graphical user interface (GUI) is shown and generally designated 700. The GUI 700 may be generated by the user device 102, the system 100 of FIG. 1, the media player 210, the system 200 of FIG. 2, the system 400 of FIG. 4, the system 500 of FIG. 5, or a combination thereof. The GUI 700 may correspond to a playback GUI associated with a particular CI. For example, the GUI 700 includes the playback GUI 242, the playback GUI 246, the playback GUI 248 of FIG. 2, the playback GUI 542, the playback GUI 548 of FIG. 5, or a combination thereof. The particular CI may include the CI 131, the CI 133, the CI 135, the CI 137, the CI(s) 139, the CI 141 of FIG. 1, the CI 431, the CI(s) 433, the CI 435, or a combination thereof.

The GUI 700 may include an image 704 associated with the particular CI. The image 704 may include a photograph, an album cover, a still from a video, or a combination thereof. To illustrate, the particular CI corresponds to a music track, and the image 704 corresponds to a photograph of a performer performing (e.g., singer, musician, etc.) in the music track, an album cover of an album that includes the music track, a still from a music video of the music track, a still from a movie that includes the music track, or a combination thereof. In a particular aspect, the GUI 700 includes a video associated with the particular CI. For example, the GUI 700 includes a music video of the music track.

The GUI 700 may include text 706 associated with the particular CI. The text 706 may include a song title, an album name, a band name, an artist name, a topic name, a genre name, or a combination thereof. For example, the particular CI corresponds to a music track, and the text 706 includes a song title of a song in the music track, an album name of an album that includes the music track, a band name of a band that performed in the music track, an artist name of an artist that performed in the music track, a topic addressed in the music track, a name of a genre of the music track, or a combination thereof.

The GUI 700 may include one or more playback options associated with the particular CI. The playback options may include a save option, a replay option 702, a stop (or cancel) option, a scan option, a skip option, or a combination thereof. For example, the GUI 700 corresponds to the playback GUI 242 associated with the CI 137. The media player 210 may, in response to receiving the ID 136 and determining that the ID 136 corresponds to the on-demand content source 111, generate the GUI 700 (e.g., the playback GUI 242) to include the replay option 702. As another example, the GUI 700 corresponds to a playback GUI associated with the CI 135. The media player 210 may, in response to determining that an ID of the CI 135 is absent from the first media stream 108, generate the GUI 700 (e.g., the playback GUI) without the replay option 702.

The GUI 700 thus enables user interaction associated with playback of the particular content item. For example, the user 103, during the playback of the particular content item, selects the replay option 702 to replay a previously received content item. The media player 210 generates a replay GUI in response to receiving the replay selection 252 indicating that the replay option 702 has been selected, as further described with reference to FIG. 8.

Referring to FIG. 8, a graphical user interface (GUI) is shown and generally designated 800. The GUI 800 may be generated by the user device 102, the system 100 of FIG. 1, the media player 210, the system 200 of FIG. 2, the system 400 of FIG. 4, the system 500 of FIG. 5, or a combination thereof. The GUI 800 may correspond to a replay GUI. For example, the GUI 800 includes the replay GUI 244 of FIG. 2, the replay GUI 544 of FIG. 5, or both.

The GUI 800 may include one or more media options corresponding to one or more identifiers indicated by the identifier list 240 of FIG. 2. For example, the GUI 800 includes a media option 802 corresponding to a first ID of the identifier list 240, a media option 804 corresponding to a second ID of the identifier list 240, a media option 806 corresponding to a third ID of the identifier list 240, or a combination thereof. At least one of the first ID, the second ID, or the third ID may correspond to the ID 130, the ID 132, the ID 136 of FIG. 1, the ID 430 of FIG. 4, or a combination thereof. For example, the first ID corresponds to the ID 130, the second ID corresponds to the ID 132, and the third ID corresponds to the ID 136. As another example, the first ID corresponds to the ID 130, the second ID corresponds to the ID 132, and the third ID corresponds to the ID 430.

The GUI 800 may include a cancel option 808. The media player 210 may, in response to receiving a user selection of the cancel option 808, provide the GUI 700 of FIG. 7 to the display 204. For example, the media player 210, in response to receiving a user selection of the cancel option 808, provides a playback GUI corresponding to a CI to the display 204 concurrently with providing the CI to the speaker 206.

The GUI 800 thus enables replay of a previously received CI. For example, the GUI 800 includes a media option corresponding to a previously received CI that is replayable. The media player 210 determines that a CI is replayable in response to determining that the identifier list 240 includes an ID of the CI that corresponds to the on-demand content source 111 (or another on-demand content source). The media option is selectable by the user 103 to replay the CI.

Referring to FIG. 9, a method of radio content replay is shown and generally designated 900. The method 900 may be performed by the user device 102, the system 100 of FIG. 1, the media player 210, the system 200 of FIG. 2, or a combination thereof.

The method 900 includes receiving a media stream corresponding to a live radio broadcast, at 902. For example, the user device 102 of FIG. 1 receives the first media stream 108 corresponding to a live radio broadcast, as described with reference to FIG. 1. The first media stream 108 may include the CI 131 and the ID 130 of the CI 131.

The method 900 also includes providing data to a display in response to receiving a replay selection, at 904. For example, the media player 210 of FIG. 2, in response to receiving the replay selection 252, provides data corresponding to the replay GUI 244 to the display 204. The replay GUI 244 may correspond to the identifier list 240, as described with reference to FIG. 2. The identifier list 240 may include IDs of a plurality of received CIs. For example, the identifier list 240 includes the ID 130, the ID 132, the ID 136, or a combination thereof.

The method 900 further includes receiving an input indicating a particular identifier of the list of identifiers, at 906. For example, the media player 210 of FIG. 2 receives the input 254 indicating a selection of the ID 130 of the identifier list 240.

The method 900 also includes sending a request, via a network, to a remotely located on-demand content source, at 908. For example, the user device 102 of FIG. 1 sends the request 112, via the network 150, to the on-demand content source 111 (e.g., a remotely located on-demand content source). The request 112 may include the ID 130.

The method 900 further includes receiving a particular content item from the on-demand content source, at 910. For example, the user device 102 of FIG. 1 receives the CI 131 from the on-demand content source 111. The CI 131 may correspond to the ID 130.

The method 900 thus enables the user device 102 to request a previously received CI from the on-demand content source 111. The user device 102 replays the CI received from the on-demand content source 111.

Referring to FIG. 10, a method of radio content replay is shown and generally designated 1000. The method 1000 may be performed by the user device 102, the system 100 of FIG. 1, the media player 210, the system 200 of FIG. 2, or a combination thereof.

The method 1000 includes receiving a media stream corresponding to a live radio broadcast, at 1002. For example, the user device 102 of FIG. 1 receives the first media stream 108 corresponding to a live radio broadcast. The first media stream 108 may include a CI 131 and the ID 130 of the CI 131. The ID 130 may be associated with the on-demand content source 111 (e.g., a remotely located on-demand content source), as further described with reference to FIG. 1.

The method 1000 also includes generating a first graphical user interface (GUI) including at least a replay option, at 1006. For example, the media player 210 of FIG. 2 generates the GUI 700 (e.g., the playback GUI 242) including at least the replay option 702, as further described with reference to FIG. 7.

The method 1000 further includes providing the first GUI to a display, at 1008. For example, the media player 210 of FIG. 2 provides the GUI 700 (e.g., the playback GUI 242) to the display 204.

The method 1000 also includes receiving a first input indicating a selection of to the replay option, at 1010. For example, the media player 210 of FIG. 2 receives the input 254 indicating a selection of the replay option 702, as described with reference to FIGS. 2 and 7.

The method 1000 further includes generating a second GUI including a plurality of options, at 1012. For example, the media player 210 of FIG. 2 generates the replay GUI 244 (e.g., the GUI 800) including the media option 802, the media option 804, the media option 806, or a combination thereof. Each of the media option 802, the media option 804, the media option 806, or a combination thereof, may correspond to a particular ID of the identifier list 240, as further described with reference to FIG. 8. The identifier list 240 may include the ID 130.

The method 1000 also includes providing the second GUI to the display, at 1014. For example, the media player 210 of FIG. 2 provides the replay GUI 244 (e.g., the GUI 800) to the display 204.

The method 1000 thus enables the user 103 to select the replay option 702 of the GUI 700 to initiate display of media options corresponding to replayable CIs. The user 103 may select one of the media options to replay a corresponding CI.

FIG. 11 is a block diagram of a computing environment 1100 including a computing device 1110 that is operable to support aspects of computer-implemented methods, computer program products, and system components according to the present disclosure.

The computing device 1110 includes at least one processor 1120 and the memory 232 (e.g., a system memory). For example, the computing device 1110 includes a mobile phone, a mobile phone, a communication device, an entertainment device, a desktop computer, a laptop computer, a tablet computer, a server, a cloud computing device, or any other fixed or mobile computing device. The at least one processor 1120 may include the media player 210. Depending on the configuration and type of computing device, the memory 232 may include volatile (such as random access memory or “RAM”), non-volatile (such as read-only memory or “ROM,” flash memory, and similar memory devices that maintain stored data even when power is not provided), a combination thereof, or some other memory. The memory 232 may store an operating system 1132, program data 1138, or both. The program data 1138 may include the analysis data 234 of FIG. 2. In an illustrative aspect, the computing device 1110 corresponds to the user device 102 of FIG. 1.

The computing device 1110 may also have additional features or functionality. For example, the computing device 1110 includes removable and/or non-removable additional data storage devices, such as magnetic disks, optical disks, tape, and memory cards. Such additional storage is illustrated in FIG. 11 by a data store 1140. Computer-readable or processor-readable storage media may include volatile and/or non-volatile storage and removable and/or non-removable media implemented in any technology for storage of information such as computer-readable instructions, data structures, program components or other data. Each of the memory 232 and the data store 1140 is an example of computer storage media (e.g., a computer-readable storage device). The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, and other non-transitory media that can be used to store information and that can be accessed by the computing device 1110. Any such computer storage media may be part of the computing device 1110.

The computing device 1110 may also have one or more input devices, such as an external device 1162 connected via one or more input interfaces 1160. The input interfaces 1160 may include the input interface 224. One or more output devices, such as the display 204, speakers, a printer, etc. may also be connected to the computing device 1110 via one or more output interfaces 1170. The input interfaces 1160 and the output interfaces 1170 may each include one or more wired or wireless interfaces, such as a universal serial bus (USB) interface, a video graphics array (VGA) interface, a serial interface, a digital visual interface (DVI), a high-definition multimedia interface (HDMI), or some other interface. In certain aspects, such as when the computing device 1110 is a server, the input interfaces 1160 and the output interfaces 1170 are not included. The computing device 1110 has one or more communication interfaces 1180 that enable the computing device 1110 to communicate (e.g., via a network) with other computing devices 1122, such as the first radio content source 101, the network device 104, the on-demand content source 111 of FIG. 1, the second content source 401 of FIG. 4, or a combination thereof. The one or more communication interfaces 1180 may include the interface 220, the interface 222 of FIG. 2, or both.

Particular aspects of disclosed techniques are implemented in conjunction with a client-server architecture. To illustrate, the computing device 1110 includes an application server or other server that provides access to web radio and on-demand content. In a particular aspect, the computing device 1110 corresponds to a mobile device configured to execute an application that enables access to web radio and on-demand content. For example, one or more components of the computing device 1110 are integrated into the mobile device configured to execute the application. The application may correspond to one or more instructions that are executable to perform one or more operations described with reference to FIGS. 1-11.

It will be appreciated that not all of the components or devices illustrated in FIG. 11 or otherwise described in the previous paragraphs are necessary to support aspects as herein described. It will also be appreciated that the computing device 1110 may have additional or different components or devices than illustrated in FIG. 11 or otherwise described in the previous paragraphs.

Although the exemplary aspects described herein are intended to enable a person skilled in the art to practice such aspects, it should be understood that other aspects may be realized and that logical and physical changes may be made without departing from the scope of the present disclosure. Thus, the detailed description herein is presented for purposes of illustration only.

In one aspect, portions of the present disclosure may be implemented using a system that includes a software module, logic engines, computer hardware, databases, and/or computer networks. Moreover, while the description may make reference to specific technologies, system architectures, and data management techniques, it will be appreciated that other devices and/or methods that use different technologies, architectures, or techniques may be implemented without departing from the scope of the disclosure. This disclosure is intended to cover any and all subsequent adaptations or variations of various aspects.

As will be appreciated by one skilled in the art, some aspects may be embodied as a system, method, or computer program product. Accordingly, some aspect may take the form of an entirely hardware implementation, an entirely software implementation (including firmware, resident software, micro-code, etc.) or a combination of software and hardware aspects that may all generally be referred to herein as a “circuit,” “module,” or system.” Furthermore, some aspects may take the form of a computer program product embodied in a tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, radio frequency (RF), etc. Computer program code for carrying out operations of the disclosure may be written in any combination of one or more programming languages, including an object oriented programming language, such as Java, Smalltalk, C++, or the like, and conventional procedural programming languages, such as the “C” programming language, or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Various aspects are described with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create mans for implementing the functions/acts specified in the flowchart and/or block diagram block or blocks. The computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in FIGS. 1-11 illustrate the architecture, functionality, and operation of possible implementations of systems, methods, and computer program products according to various disclosed aspects. In this regard, each block in the flowchart or block diagrams may represent a module, a segment, or a portion of code, which includes one or more executable instructions for implementing the specified logical function(s). It should also be noted that, in some alternative implementations, the functions noted in the block occur out of order noted in the FIGS. 1-11. For example, two blocks shown in succession are, in fact, executed substantially concurrently, or the blocks are sometimes executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope and spirit of this technology. Some implementations were chosen and described in order to explain the principles and practical application, and to enable others of ordinary skill in the art to understand various implementations with various modifications as are suited to particular uses contemplated.

The Abstract is not intended to be used in interpreting or limiting the scope or meaning of the claims. In addition, the disclosure is not to be interpreted as indicating that the claimed aspects require more features than are expressly recited in each claim. Thus, the present disclosure is not intended to be limited to the aspects shown herein but is to be accorded the widest scope possible consistent with the principles and novel features as defined by the following claims.

1. A device comprising:
a first interface configured to receive a media stream corresponding to a live radio broadcast, the media stream including a content item and an identifier of the content item;
a processor coupled to the first interface and configured to:
provide data to a display in response to receiving a replay selection, the data corresponding to a list of identifiers of a plurality of received content items;
receive an input indicating a particular identifier of the list of identifiers; and
a second interface coupled to the processor and configured to:
send a request, via a network, to a remotely located on-demand content source, the request including the particular identifier; and
receive a particular content item from the on-demand content source, the particular content item corresponding to the particular identifier.

2. The device of claim 1, wherein the media stream is received from a radio content source that is remotely located from the on-demand content source.

3. The device of claim 1, wherein a first content item of the plurality of received content items is received via the media stream, and wherein a second content item of the plurality of received content items is received via a second media stream.

4. The device of claim 1, wherein the processor is further configured to, in response to receiving the identifier of the content item via the media stream:
remove a second identifier from the list of identifiers; and
add the identifier to the list of identifiers prior to providing the data to the display.

5. The device of claim 1, wherein the processor is further configured to, in response to receiving the identifier in the media stream, add the identifier associated with the on-demand content source to the list of identifiers prior to providing the data to the display.

6. The device of claim 1, wherein the processor is further configured to:
generate a first audio signal based on the particular content item received from the on-demand content source;
generate a second audio signal based on the media stream corresponding to the live radio broadcast; and
output the second audio signal via a speaker subsequent to outputting the first audio signal via the speaker.

7. The device of claim 1, wherein the data corresponds to a graphical user interface (GUI) including media options, wherein the media options correspond to the list of identifiers, and wherein the input indicates a selection of a particular media option corresponding to the particular identifier.

8. The device of claim 1, wherein at least one of the first interface, the second interface, or the processor is integrated into a mobile device configured to execute an application that enables access to web radio and on-demand content.

9. A method comprising:
receiving, at a device, a media stream corresponding to a live radio broadcast, the media stream including a content item and an identifier of the content item, wherein the identifier is associated with a remotely located on-demand content source;
generating, at the device, a first graphical user interface (GUI) including at least a replay option;
providing the first GUI to a display;
receiving a first input indicating a selection of the replay option;
generating a second GUI including a plurality of options, each option of the plurality of options corresponding to a particular identifier of a list of identifiers, wherein the list of identifiers includes the identifier; and
providing the second GUI to the display.

10. The method of claim 9, further comprising:
receiving, at the device, a second input indicating a selection of a first option corresponding to a first identifier of the list of identifiers;
sending a request from the device, via a network, to the on-demand content source, the request including the first identifier; and
receiving, at the device, a first content item from the on-demand content source, the first content item corresponding to the first identifier.

11. The method of claim 10, wherein a royalty system generates a first royalty entry based on inclusion of the first content item in the media stream, and generates a second royalty entry based on sending the first content item from the on-demand content source to the device.

12. The method of claim 10, wherein a tracking system generates broadcast metrics based at least in part on inclusion of the first content item in the media stream, and generates replay metrics based at least in part on sending the first content item from the on-demand content source to the device.

13. The method of claim 10, further comprising:
generating a first audio signal based on the content item received from the on-demand content source;
generating a second audio signal based on the media stream corresponding to the live radio broadcast; and
outputting the second audio signal via a speaker subsequent to outputting the first audio signal via the speaker.

14. The method of claim 10, further comprising, prior to generating the first GUI, receiving the first identifier in a second media stream.

15. The method of claim 14, wherein the second media stream corresponds to a second live radio broadcast, wherein the live radio broadcast is associated with a first radio station, and wherein the second live radio broadcast is associated with a second radio station that is distinct from the first radio station.

16. The method of claim 9, wherein the first GUI includes data associated with the content item, and wherein the replay option is included in the first GUI in response receiving the identifier of the content item that is associated with the remotely located on-demand content source.

17. The method of claim 16, wherein the data includes text, an image, or both.

18. A computer-readable storage device storing instructions that, when executed by a processor, cause the processor to perform operations comprising:
receiving a media stream corresponding to a live radio broadcast, the media stream including a content item and an identifier of the content item;
providing data to a display in response to receiving a replay selection, the data corresponding to a list of identifiers of a plurality of received content items;
receiving an input indicating a particular identifier of the list of identifiers;
sending a request, via a network, to a remotely located on-demand content source, the request including the particular identifier; and
receiving a particular content item from the on-demand content source, the particular content item corresponding to the particular identifier.

19. The computer-readable storage device of claim 18, further comprising:
outputting a first audio signal via a speaker, the first audio signal based on the particular content item received from the on-demand content source; and
subsequent to outputting the first audio signal via the speaker, outputting a second audio signal via the speaker, the second audio signal based on a second media stream.

20. The computer-readable storage device of claim 18, wherein the particular content item includes a music track, a talk show, a news report, a weather report, a traffic report, an advertisement, or a combination thereof.
